(19) United States
(12) Patent Application Publication
(10) Pub. No.: US 2009/0199457 A1
(43) Pub. Date: Aug. 13, 2009

(54) METHODS AND DEVICES FOR PEST CONTROL

(76) Inventors: Grigor Rangelov Grigorov, Sofia (BG); Aleksey Dimitrov Dobryanov, Sofia (BG)

Correspondence Address: BROWN & MICHAELS, PC;400 M & T BANK BUILDING, 118 NORTH TIOGA ST, ITHACA, NY, 14850, US

(21) Appl. No.: 11/719,454

(22) PCT Filed: Nov. 25, 2005
(86) PCT No.: PCT/BG05/00018

§ 371 Date: May 16, 2007

(30) Foreign Application Priority Data
Nov. 26, 2004 (BG) 108950

(51) Int. Cl. A01M 23/38; A01M 1/02; A01M 1/22

(52) U.S. Cl. 43/99

(57) ABSTRACT

The methods and devices can be applied in households, industry, healthcare, agriculture, forestry and other for immobilization and extermination of pests. They are complex, universal ecological and with improved effectiveness and productivity. The device on FIG. 1 consists of a conical inclined platform (1), which together with an upper conical cover (19), attached to platform (1) with pop-up connections (13) through transient circular platform (14), form an integrated corridor (15) along the conference of the device at the upper end of conical inclined platform (1) by the circular platform (14) is linked the wider end of a funnel (2), the lower (narrower) end is positioned centrally above a mobile container (6), where the enticement (7) is placed, where a zero electric truck (3) and phase electric truck (4) are attached one after another on the inside surface of the funnel (2).

### FIELD OF THE INVENTION

The present invention relates to methods and devices for pest control, applicable to household activities, industry, agriculture and timber industry, etc.

### PRIOR ART

A method for exterminating pests is known BG (62467), where killing the pest with electric spark completes extermination. Under the influence of enticement, the pest is directed into space, limited by two electric trucks, with which he is compelled to come into contact on the way towards the enticement. The pest is in contact with one of the electric trucks while moving on it. Depending on the weight of the pest is determined the electric voltage, necessary to form a discharges in the space between the electrodes, which kills it. The pest is directed ill the space between the electrodes and is forced to climb to certain height. The voltage between the two electric trucks is switched on, after the pest has entered the space between the electric trucks. The corpse of the exterminated pest is removed from the space between the electric trucks by sliding down the slope under its own weight toward the place for collecting corpses. After that the electric voltage between electrodes is switched off and the device is left in stand by mode, waiting for a new cycle of pest extermination.

According to method, it is possible that the electric voltage is switched on continuously between lower bottom electric truck and middle part of upper electric truck and is passed toward two outlying parts of upper electric trick immediately after the pest has entered the zone under the middle part of upper electric truck.

According to method, it is possible define the height of the electric voltage, between the two electric trucks, is such way as to insure the extermination of creep pests of pre-defined size. In this case the electric voltage between the two electric trucks, insures the extermination of pests when they are attempting to reach the enticement.

A device is known (BG 62467), which is implementing the same method for exterminating pests, which consists of a corridor with upper electric truck situated over its floor, connected to a switch, which is connected with phase source of height electric voltage. The floor is placed over a spring, the enticement is placed in a corridor, which is sloping and is on a prop. The enticement is placed in lower end of corridor, the floor is the lower electrode, connected to the point of a rheostat, connected to the zero conductor of a source of high voltage. The springs are arched and leaf shaped. To the upper opening of corridor is positioned removable inclined furrow with a cross section, which is compatible with the size of the biggest pests to be exterminated. Under the lower opening of the corridor is positioned a second inclined furrow toward the container. In an opening in the floor is situated light emitter, and over it a light sensor, whose output is connected to first control input of the contactor, and to the input contact of a timer, which output is connected to the second input lead of the contactor.

A common disadvantage of the known methods and devices for exterminating pests is, that they have low productivity and low effectiveness, as they require the pest to be in a continuous contact with a single electric truck. Other disadvantage is that the height of corridor is limited by the distance between the electric trucks, which define the type of pest, after extermination, their corpses become stiff with dimensions nearly the size of the cross section of the corridor and thus arise the possibility to plug up the opening. Other disadvantage is, that the continuously switched on electric voltage, could be felt from afar by some pests and they would instinctively run away from the zone of extermination. Some variants of the known devices are difficult for maintain and use.

The aim of this invention is to create complex, universal and ecological methods and structure for pest control, with high effectiveness and productivity.

### TECHNICAL DESCRIPTION OF THE INVENTION

This task is solved, by creating methods for pest control, where the immobilization or extermination of pests is achieved by electrical, laser, ultrasound, and electromagnetic or other influences. Under the influence of a enticement the pest is brought up to certain height, after it follows down along an inclined surface toward the zone for immobilization or extermination, where after registration of its presence and recognition, the immobilization or extermination impulse is applied only on recognized pre-defined pest type. Removal of the body of the immobilized or exterminated pest is achieved by sliding down the slope under the action of its own weight toward a receptacle designated for accumulation of bodies and corpses (bucket or pit in case field implementation), after that the influence is turned off and the process is in stand-by mode, ready for a new cycle—awaiting a new pest.

According to the methods the pest could approach the extermination zone from all directions via an integrated corridor. Landing on the inclined surface or over the container of flying insect and feathered pests is also defined as motion toward the enticement. Immobilization or extermination influence is activated after the pest has entered the impact zone, which is determined by sensors for presence and/or identification—photo, video, ultrasound, capacity (contact sensors), inductive, termal, infra-red, laser, electromagnetic and etc., determined in every specific case.

According to the methods it is possible that the pest is directed to the zone of impact, which is defined as the space limited by two electric trucks, without having to touch either electric truck, however the pest is moving towards the enticement along a down sloping surface. The voltage between the two electric trucks is switched on after the pest has entered into the space between the electrodes by activating the sensors for presence and/or recognition, which is connected to a microprocessor. After self-cleaning of the impact zone, the electric voltage between the electrodes is switched off and the system is ready for a new cycle in stand-by mode.

According to the methods, it is possibly to exterminate the pests by using laser, ultrasound, electromagnetic and other influences. In that case, their presence is registered, the pest is identified through the use of sensors for presence and/or for identification and than the microprocessor switches on the contactor, which activates the laser or the directional ultrasounds or electromagnetic waves, where the same sensors take part in determining the required extermination impulse for the pest.

Systems for pest control are being developed, where in one of the possible solutions the device consists of a conical inclined platform and upper conical cover, which is connected to the inclined platform with push-button connections which pass-though a circular platform. The inclined platform, the middle circular platform and upper conical cover form an integrated corridor around the circumference of the structure. To the upper end of the conical inclined platform through the circular platform, which has a square opening on middle, is affixed the wider opening of funnel-shaped furrow, which lower narrow opening is positioned over removable pail, in which is positioned the enticement. The electrodes are affixed next to each other on the inner surface of funnel-shaped furrow, while light-emitter and the corresponding to them light sensors are situated in the space between the electrodes and in the corners of the funnel-shaped furrow. The electric truck, which is situated higher, is connected to the zero lead, while the lower—to the phase lead of the electric power source, while a sensor which identifies that the pail is taken out is connected to the control lead of a contactor switch for the high voltage power source. On the inside and in the centre of upper conical cover is positioned the sensor for pest recognition, which is connected with the control lead of the microprocessor, an other input lead of the microprocessor is connected to the light sensors, while the output lead of the microprocessor is connected to the control input lead of the contactor, which switches the source of high voltage, all electronic blocks are connected to a power supply.

It is possible that the upper cone-formed cover and affixed to it sensor for recognition to be missing, while in the funnel-shaped furrow are situated more than the two electric trucks with the adequate light-emitters and light-sensors in the zones between them. Accesses to the enticement is limited by a net, around the entire circumference of furrow and in the space between the electrodes are made holes for radiating the fragrance of the enticement, while if required, on the push-button connections a protective cover from heavy net could be installed.

It is possible at the upper end of inclined platform, with push-button footbridges, to attach a second conical platform, where enticement is placed. At the upper end of conical platform is attached a spherical platform, where around the entire circumference of both platforms are attached next to each other electric trucks, which could be more than two. In spaces between the electrodes are made holes from which the enticement fragrance emanates. Enticement is placed in the spherical platform as well. The first inclined platform lies on the container, and through holders are positioned sensors for presence and recognition, which are connected to the input lead of the microprocessor, which output through contactor is connected to the control input of source of high voltage, while all electronic blocks are connected to a power supply.

It is possible that a container is hang on a cord, where at the upper end a rod-like platform is attached, which is the minus electric truck, and at a distance defined by the size of the pest, trough isolation tip is positioned the phase electric truck. Sensor for presence and recognition is placed at one end of rod-like platform, the output from the sensor is connected with the input lead of the microprocessor, which via a contactor is connected to the input of the control circuited of the source of high voltage, all electronic blocks are connected to a power supply block, under the rod-like platform is attached a vessel-rack with enticement.

It is possible that the inclined platform is actually part of a slope in landscape, on which furrow is shaped in slant wall of pit, which in this case is part of the container and at which bottom the enticement is placed. The zero electric truck is positioned on the surface around the perimeter of the pit, while the phase electric truck is placed over the lower electrode of a height, defined by the type of pest to be exterminated, on isolation tips attached to supports, which could be live trees. On each support is positioned one sensor for presence and recognition with overlapping observation sectors for of respective zone for elimination. The output leads of the sensor are connected to the microprocessor via transmitter, to the power supply block a solar panel is connected, attached to one of the supports and/or power supply cable from the stationary power grid.

It is possible that the inclined furrow is made along the slope of the landscape, where on both sides of an animal truck are placed supports, on one of which is placed a sensor of presence and recognition, which trough transmitter is connected to a microprocessor. The phase electric truck is attached to isolation tips, which are placed on the supports over the truck, under it, on surface of the terrain is positioned the zero electric truck. The container with enticement is placed in a pit, positioned downhill along the slope, and the power supply block is connected to a solar panel and/or cable attached to the stationary power grid.

It is possible that the electrodes are installed vertically and are positioned on both sides of an animal truck placed on supports, which could also be live trees.

It is possible, that a conical inclined platform is affixed to a circular platform with square opening in the middle to the wide opening of inclined funnel-shaped furrow, which lower narrow opening is positioned centrally over a container. In it on a stand is attached a conical umbrella, on which is placed the enticement. A sensor for removed container is connected to the input lead of a switch, which is connected to the control circuit of the maim switch. With push-button connections, over the entire opening of funnel-shaped furrow is placed a protective cover. On the inside and in the centre of cover is situated a sensor for presence and recognition, which output lead is connected to the relevant input lead of the microprocessor and the source of exterminating influence, positioned on all walls of funnel-shaped furrow, while all electronic and electric blocks are connected to the power supplying block.

It is possible that, the inclined furrow consists of two ramps made of cloth, forming a bridge with a break over drain canal, between the ramps is attached the enticement. To the transverse beam of a U-shaped console, attached to both sides of the drain canal is placed a sensor for presence and identification, while against each ramp are positioned the relevant sources of exterminating influence, connected to the power supply block.

It is possible that a container is hang on cords, where at the upper end of prolong porter is attached a rod-like platform, at one end of this platform the sensor for presence and identification is attached, which is connected to a microprocessor and a source of exterminating influence, connected to the power supply block while from the other end of the rod is placed a shielding surface, and under the rod-like platform is positioned vessel-rack with enticement.

An advantage of the methods and structures for pest control is that they are complex, universal and ecological and with high effectiveness and productivity.

### DESCRIPTION OF THE FIGURES

In greater detail the invention is illustrated by examples of possible implementations of devices/structures, utilizing the methods for pest control, shown in the attached figures, where:

FIG. 1 is a device for extermination of creeping insect and small mouse pests;

FIG. 2 is a view from above of the device shown on FIG. 1;

FIG. 3 is a view from above of a variation of the device for extermination of flying insect pests;

FIG. 4 is a device for combined extermination of creep and flying insect pests;

FIG. 5 is a device for immobilization and/or extermination of feathered pests (birds);

FIG. 6 is a variation of the system for immobilization and/or extermination of large pests in field conditions;

FIG. 7 is a first variant of a system for immobilization and/or extermination of large pests in their natural habitats;

FIG. 8 is a second variant of a system for immobilization and/or extermination of large pests in their natural habitat;

FIG. 9 is a system for extermination of small mammal pests;

FIG. 10 is system for extermination of pests beside drain canals,

FIG. 11 is a system for extermination of bird pests;

### EXAMPLES OF CARRYING OUT THE INVENTION

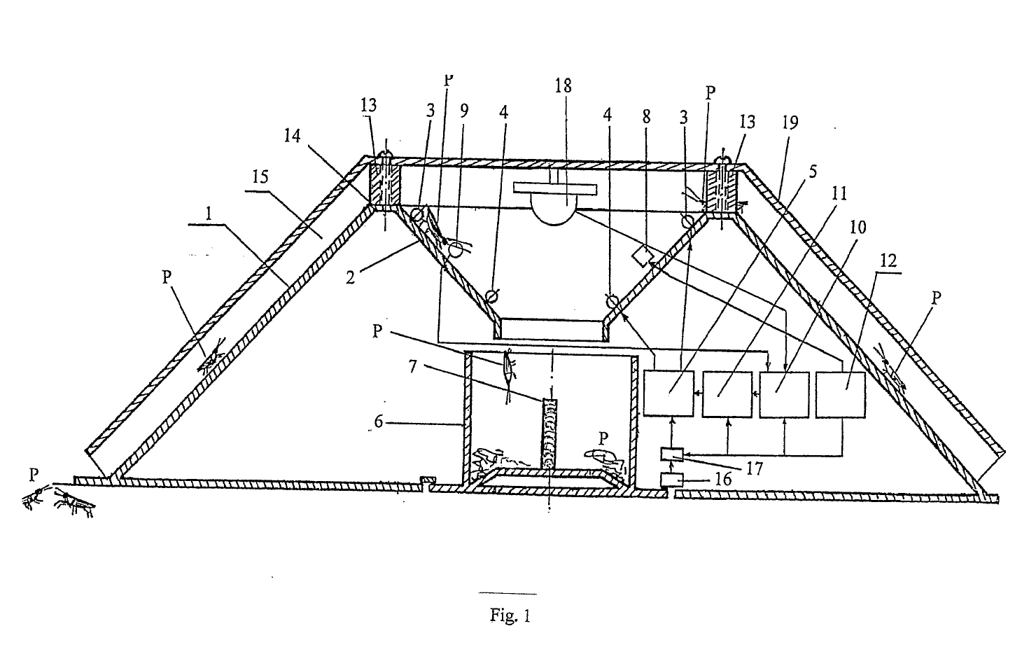

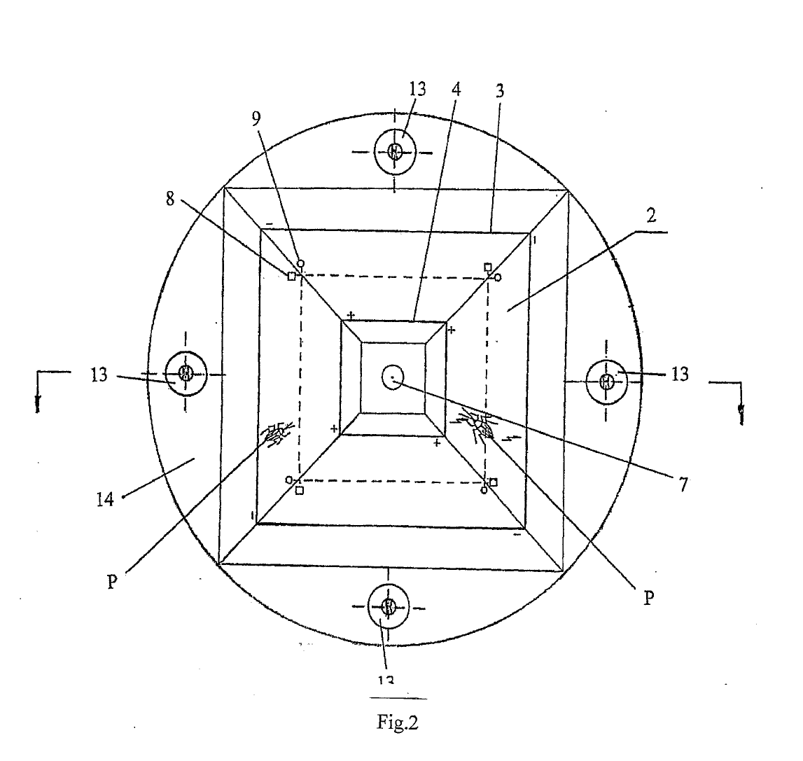

The device for exterminating pests shown on FIG. 1 and FIG. 2 consist of conically shaped inclined platform 1 and upper conical cover 19, attached to the platform 1 with push-button connections 13, which pass trough the circular platform 14, which together form the integrated corridor 15 around the circumference of the device. To the upper end of the conical inclined platform trough the circular platform, which has a square opening on middle, is attached the wide end of a furrow 2, which is funnel-shaped and tetrahedral, at its lower narrow opening is positioned a mobile container 6, in which is placed the enticement 7. The electric trucks 3 and 4 are attached one after another on the inner surface of funnel-shaped furrow 2, while the light emitters 8 and the respective light sensors 9 are situated in corners of every pair of adjacent walls of furrow 2 between the electrodes 3 and 4, where the upper electric truck 3 is connected to the zero, and the lower electric truck 4 is connected to phase lead of the source of high voltage electric power 5. The sensor 16 for removed container 6 is connected to the control input of switch 17, which is switching on/off the source of high voltage 5. On the inner wall and in the center of the top conical cover is positioned the sensor for recognition 18, which is connected to the control lead of the microprocessor 10. The other input lead of the microprocessor 10 is connected to the light sensors 9, where the output of the microprocessor 10 through the control input of switch 11 is connected to the source of a high voltage 5, where all electronic blocks are connected to the power supply block 12.

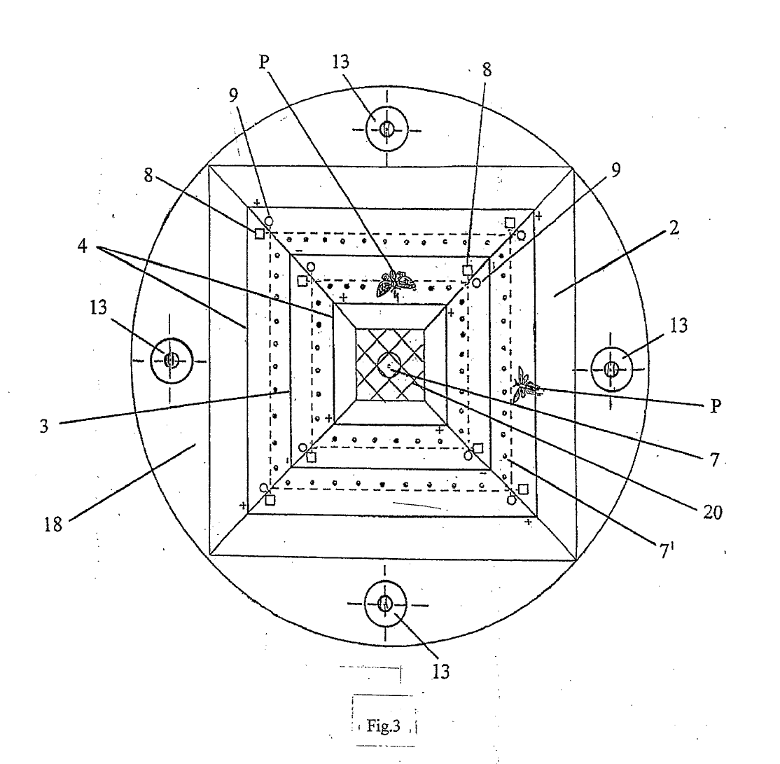

In the device for extermination of pests shown on FIG. 3 in the funnel-shaped furrow are installed more than one pair of electric trucks 3 and 4 with required light emitters 8 and light sensors 9 in the zones between the trucks. Access to the enticement 7 is restricted by a net 20, while around the entire circumference of a furrow 2 in the space between the electrodes are made opening 7′ to emanate the fragrance of the enticement 7, while the missing conical cover 19 can be replaced by protective cover made from heavy net, affixed by the push-button connections 13.

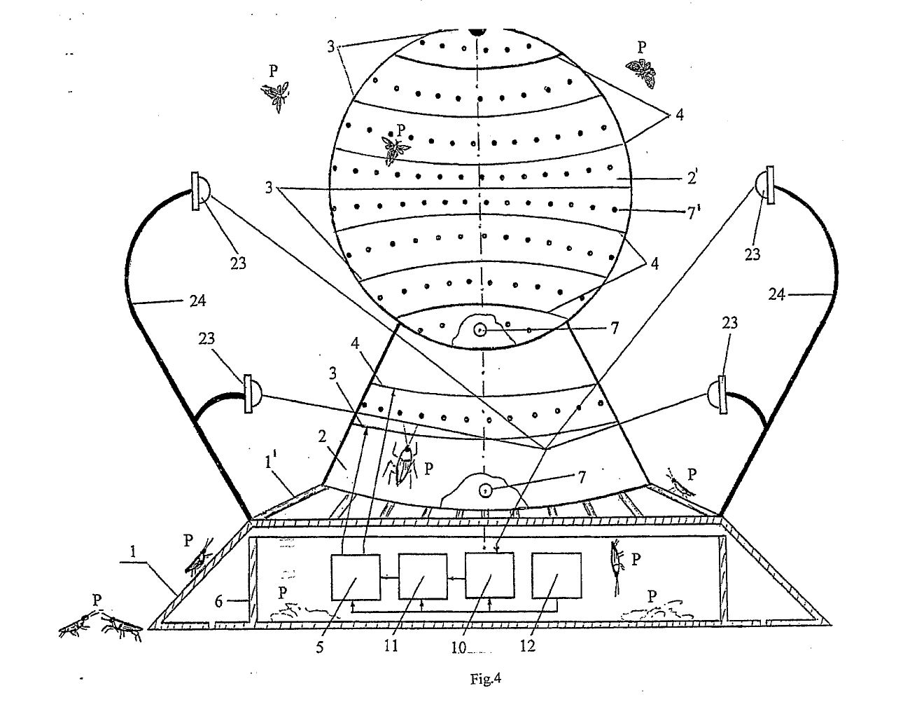

In the device for extermination of pests, shown on FIG. 4, at upper end of the inclined platform 1 by push-button bridges 1′ is attached the conical platform 2 with the enticement 7 inside and at the upper end is attached a monolithic spherical platform 2′, inside which the enticement 7 is placed. The zero electric trucks 3 and phase electric trucks 4 are placed one after another on outer surface of conical platform 2 and the spherical platform 2′, and along their circumference in the space between the electrodes are made openings 7′ to emanate the fragrance of the enticement 7. The inclined platform 1 is placed on the container 6, and by holders 24 the sensors for presence and recognition 23 are positioned, which are connected to the input lead of a microprocessor 10, which output through a switch is connected to the control input of a source of a high voltage 5, which together with the remaining electronic blocks are connected to the power supply block 12.

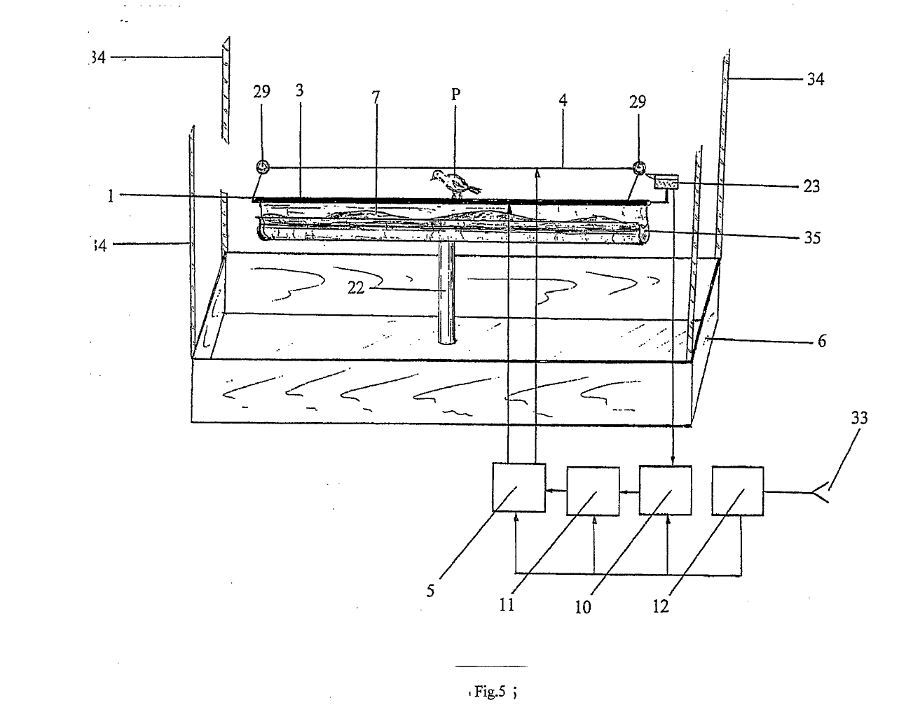

The system for immobilizing and/or extermination of feathered pests, shown on FIG. 5, is a container 6, hanging on cords 34, at the upper end of a beam 22 is attached rod-like platform 1, which is the zero electric truck 3. In a distance, defined by the type of pests to be exterminated, on insulation tips 29 is positioned phase electric truck 4. At one end of the rode-like platform 1 is positioned the sensor for presence and recognition 23, which output is connected to the input of the microprocessor 10, which through a switch is connected to the input lead of high voltage power source 5, all blocks are connected to the power supply block 12.

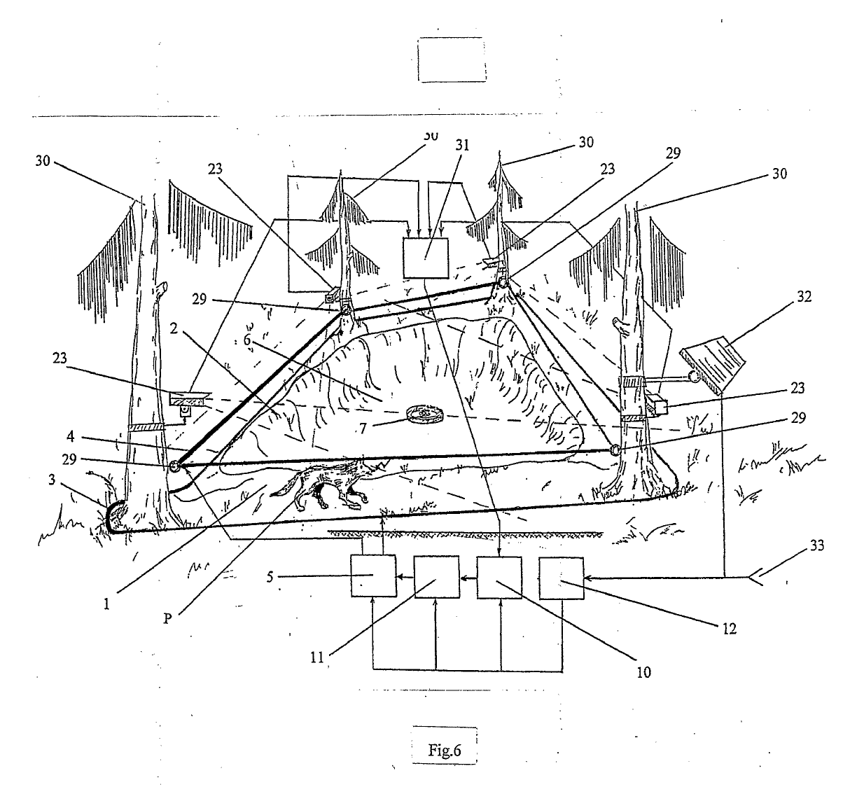

The system for immobilizing and/or exterminating pests, as shown on FIG. 6, the inclined surface 1 is made as part of the slope in the landscape, in which is made a trench 2 with slightly slopping walls of pit 6 and on its bottom is placed the enticement 7. The lower electric truck 3, which is connected to the zero is positioned on the surface of the terrain and around the periphery of the pit 6, a phase electric truck is attached above the lower electric truck 3 at a height, defined by the type of pest to be exterminated. On isolation tips 29 the electric trucks are attached to the supports 30, which can also be live trees, on each of it is attached one sensor for presence and recognition 23 with overlapping sectors for observation of relevant zone. The outputs of the sensors are connected to the microprocessor 10 via transmitter 31, and to the supply block is connected a solar panel 32, attached to one of the supports 30 and/or a power supply cable connected to the power grid 33.

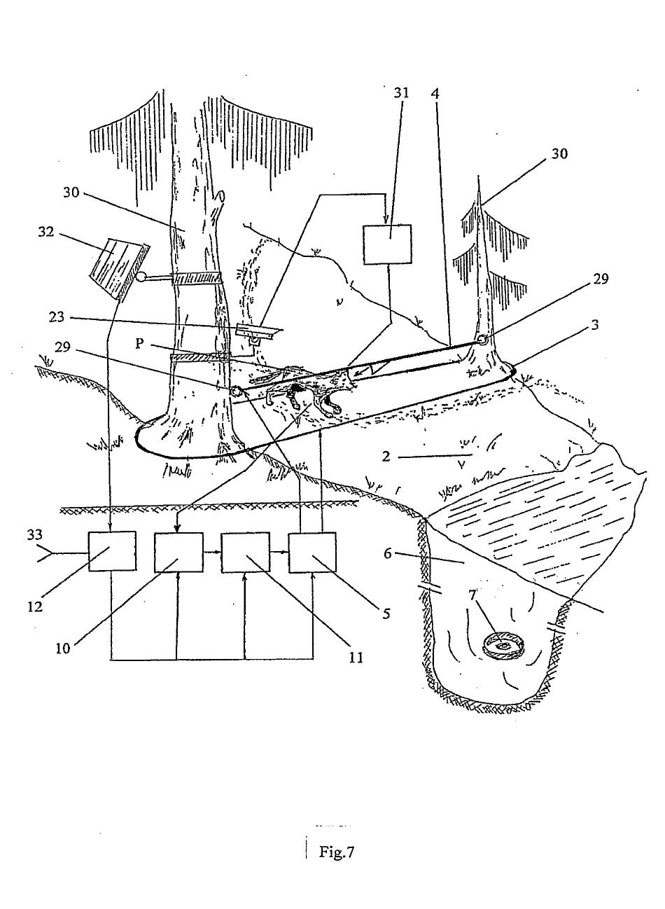

The system for immobilizing and/or exterminating pests, as shown on FIG. 7, where for the inclined furrow 2 is used the slope of the landscape, on both sides of pest's path are placed supports 30, over one of these is positioned a sensor for presence and recognition 23, which through a transmitter 31 is connected to the microprocessor 10. On isolation tips 29 is attached the electric truck 4, which is the phase and is placed over the path, under it, on the surface of the terrain is positioned the zero electric truck 3. The pit 6 with enticement 7 is positioned at a distance downhill on the slope, and to the power supply block 12 is connected a solar panel 32 and/or cable from the power supply grid 33.

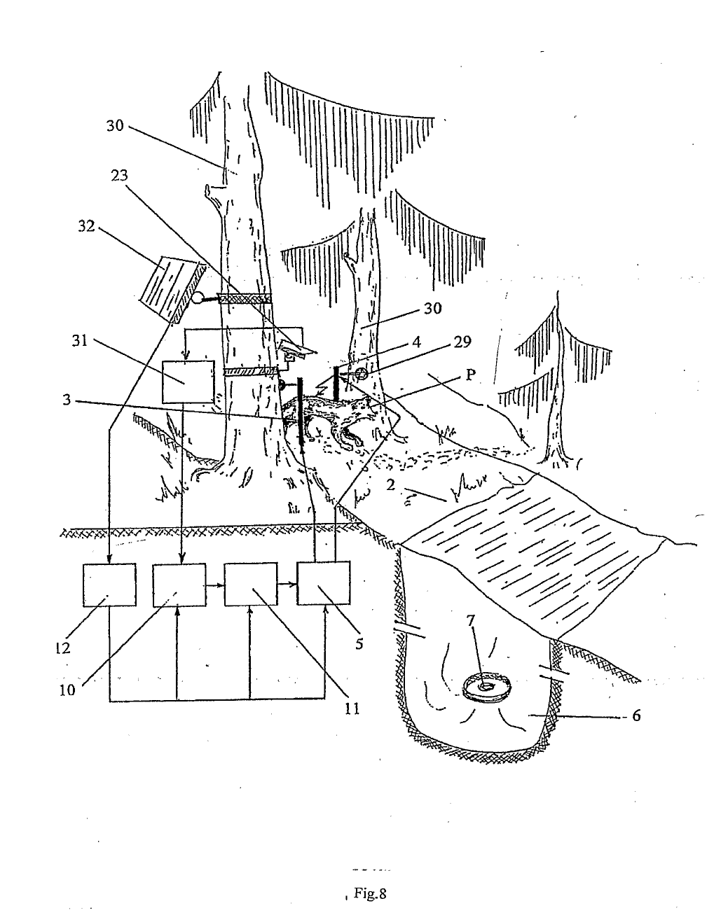

In the system for immobilizing and/or exterminating pest, as shown on FIG. 8, the electric trucks 3 and 4 are vertical and are positioned on both sides of the path on supports 30.

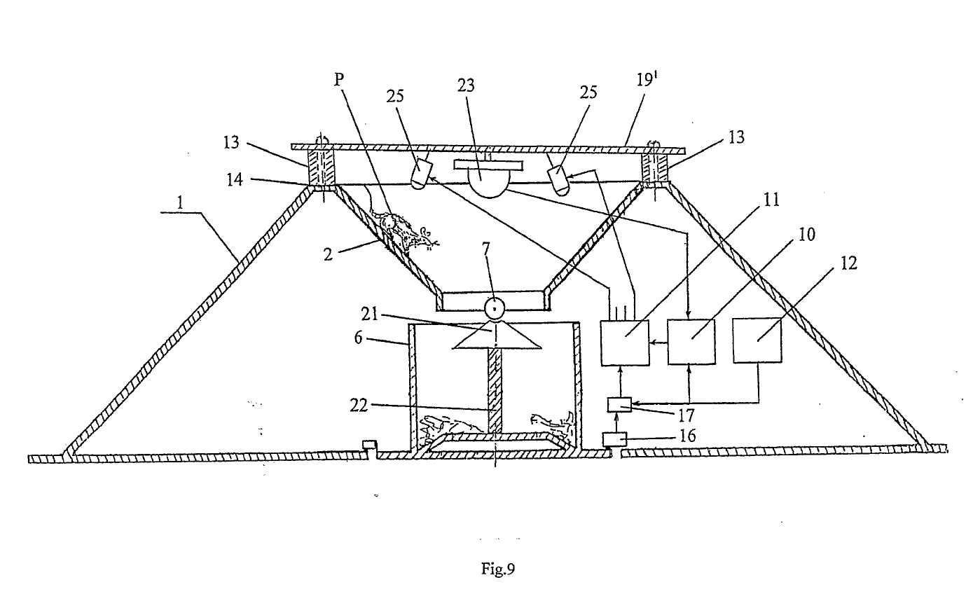

The device for exterminating pests, as shown on FIG. 9, consist of sloping conical platform 1, which trough intermediate circular platform 14 with a square opening in the middle is connected with wide end of furrow 2, which is tetrahedral and funnel-shaped. The lower narrow opening of furrow 2 is centered over the container 6, into which over a porter 22 is attached a conical cover 21, in which is placed the enticement 7. The sensor 16 for taken out container is connected to the control input 17 in the power supply circuit of the switch 11. Trough props over the upper opening of funnel is placed protective cover 19′, on the inside and in the center of which are situated sensors for presence and recognition 23, their output is connected to relevant input of the microprocessor 10 and the source of exterminating influence 25, positioned against each wall of funnel 2 and connected to the power supply block 12.

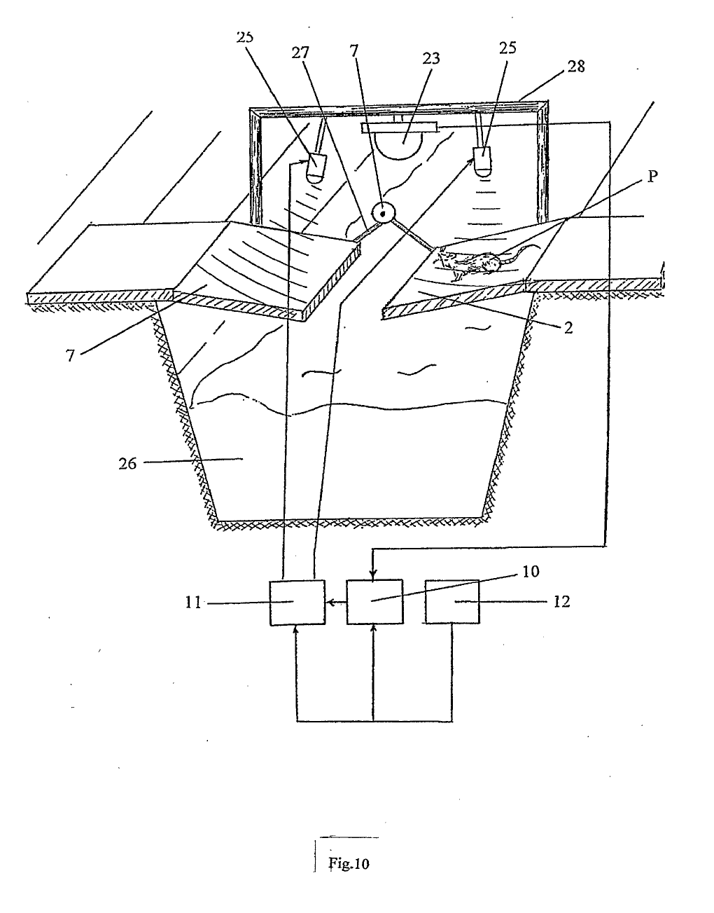

The system for extermination of pests, as shown of FIG. 10 consist of two sloping canvases 2, forming interrupted bridge over drain canal 26, with the enticement 7 attached between them with holders 27. To the cross beam of U-shaped console 28, attached to both sides of the drain canal 26 is placed the sensor for presence and recognition 23, where against each of canvases 2 are positioned relevant sources of exterminating influence 25, connected to the power supply block 12.

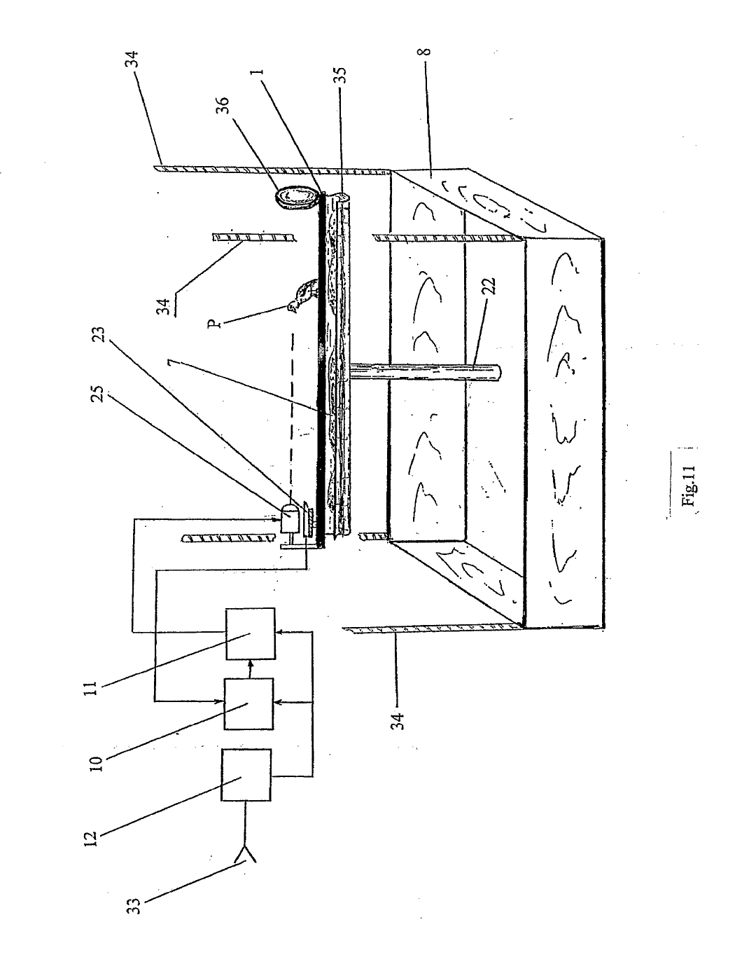

The system for extermination of pests, as shown on FIG. 11, the container 6 is hang on cord 34. While at the upper end of prolong porter 22 is attached a rod-like platform 1. At one end of the rod-like platform is placed a sensor for presence and recognition 23 and a source of exterminating influence 25, connected to the power supply block 12, at the other end is placed a screening surface 36, and under it is attached vessel-rack 35 with enticement 7.

On all figures the pests, subject of control are marked with the letter P.

### Application and Action of the Invention

The operation of the devices, implementing the methods for pest control, is as follows:

The device, explained for instance with the implementation shown on FIG. 1 and FIG. 2, for exterminating creep insect and small mice-like pests, the directing of the pest P in the space between electric trucks 3 and 4 is under the influence of the enticement 7, which fragrance spreads through the integrated corridor 15, which is forcing the pest P to climb-up the conical inclined platform 1, and than to pass through the space, limited by the electric truck 3 and 4, situated in the furrow 2. The moment, when the pest P is crossing the rays of some of light-emitters 8, its shadow falls on the relevant light-sensor 9, which sends a signal for presence of pest P to the switch 11, which trough the microprocessor 10 activates the source of high voltage 5 connected to the electric truck 3 and 4. The size of the voltage, necessary to form discharges in the space between electrodes, which would kill the pest P, is defined in advance by the distance between electric trucks 3 and 4 and the size of the pest or is determined automatically by sensor for recognition 18, the microprocessor 10 and the source of high voltage 5. Between the electric trucks 3 and 4 are formed electric discharges in the zone, where the pest P is, which may be killed at once with the initial discharges, thus there is no possibility to go back or to signal danger to the remaining individual from the population. The microprocessor is set in advance to switch off the source of a high voltage 5 after certain period of time, sufficient for exterminating even the most tenacious pest P. After that the microprocessor 10 is switched to stand-by mode and waits for a new cycle for exterminating pests P. The elimination of the corpse of the pest P from the space between the electrodes is achieved trough it's sliding down the funnel 2 toward the place for collecting of corpses—the removable container 6. For safety the devise it is switched off by a signal from the sensor 16 for removed container 6 to the switch 17, which breaks the electric circuit between the power supply block 12 and the source of high voltage 5.

The legal requirements of some countries and a number of recent international conventions bar the use in practices of nonselective methods and means for pest control. When we consider household use, there are not any protected kinds—the presence of all pests is undesirable and you have to eliminate them. In such case the sensor for recognition can be absent.

The methods for registration of presence and observation are currently on a high level (BG 26 326). In connection with the fight against international terrorism the software for identification is being developed very rapidly. We foresee that trough sensors for recognition, the microprocessor configurations and the relevant software, to be able to identify pests at least by level “family”—for example: family Dogs (wolf, jackal, fox and others), family Deer (noble deer, deer and spade, foe and others), family Bears, family Cats and so on, and when necessity—to level “kind”, which is also subject of the software. For synantroph (those which inhabit jointly with humans) pests it is enough to identify them on a level “group”—bakers, ants, flies, mice and so on.

The immobilization of some larger pests (for instance, bigger than rat) can be achieved only by use of proper parameters of electric voltage. The laser, ultrasound or electromagnetic influences in all variant of application are extermination influences.

When the device is for extermination of flying pests P (FIG. 3), for instance flies, mosquitoes, butterflies and others, the upper conical cover 19 is missing, a sequence of electric trucks 3 and 4 in the funnel with their relevant light-emitters 8 and light-sensors 9 provide more extermination zones for killing of already alighted pests P, where the movable container is covered by net 20, which prevents the free approach of flying pests P to the enticement 7 and compels them to land in the extermination zones, but allows the corpses to fall in the container 6, in the space between the electrodes are made openings for emanation of the enticement 7 flavor. If required over extended connections 13 can be placed protective cover from heavy net (not shown on figures).

When the device is for combined extermination of creep and flying insect pests (FIG. 4), the creeping pests P trough the inclined platform 1 and extended bridges 1′ on their way toward openings 7′, from which is emanating the enticement 7, climb Lip along the outer surface of conical platform 2, and the flying pests, attracted by the enticement 7, which is emanating from the openings 7′, land on spherical platform 2′, where the sensors for presence and recognition 23, situated on holders 24, registered their presence and trough microprocessor 10 and the switch 11 is switched on the source of high voltage 5, the device can be provided with an autonomous power supply block 12.

When the device is for immobilizing and/or extermination of flying (birds) pest (FIG. 5), for example sparrows in a supper market hall, warehouses for food storage and grain feed and others, the container 6 is hanged high, near the sealing, on a cord 34, with possibility in it to fall the immobilized or exterminated pests P, which have landed on the rod-like platform 1 on their way to the enticement 7, placed in vessel-rack 35 under the platform 1. The sensor for presence and recognition 23 is placed at one end of the platform 1 register and identify the pest P, and as described earlier, trough the microprocessor 10 is switching on the source of high voltage 5. The exterminated pest P under the action of own weight falls from the platform 1 in the container 6. All electric blocks are connected to the power supply block 12.

When the methods are implemented in field conditions (FIG. 6), the container 6 is shaped like a pit in the landscape with sloping walls 2, along which passes the pest P toward the enticement 7. The lower electric truck 3 is zero and is placed on the surface along the periphery of pit the 6. For support of the phase electric truck 4 are used the near by trees 30 and/or special isolated tips 29. When the pest P passes between electric trucks 3 and 4, where the height between them is defined by its size, as described above, the device trucks for presence and identification and its immobilization or extermination. The sensors for presence and recognition 23 are placed with overlapping zones for extermination. Their signals for presence of desired pest is send to the microprocessor 10 by a transmitter 31 for high-speed transmission for signals over cable in real time. In the microprocessor 10, by software the registration for presence and recognition of pest P is made and all noise factors such as rain, vibrations from wind, falling leaves and branches and other, which could cause unnecessary operation are filtered out. The activation signal from the microprocessor 10 to the switch 11, which connects the source of high voltage 5 with the electrodes 3 and 4, is passed only if the position of pest P is under the electric truck 4 and in immediate proximity to the slopping walls of the pit 6. When there is not access to the stationary power grid by the power supply block 12 is possible to build an autonomous power source, such as solar panel 32, installed at a suitable place such as the top of one of the supports 30. The power supply from the grid is also possible 33.

When the electrodes 3 and 4 are situated on the natural path of pests P (FIG. 7), the slopping surface 2 is the natural slop of surface and at a distance down the slope, depending on the terrain is made the pit 6 with enticement 7. The variant given as an example is for movement of the pest P in both directions while scouting the enticement 7. In his case on the terrain the enticement is placed first. Attracted by it, he pest P makes scouting tour around, we could always identify places, where one or more pests have passed repeatedly. At these places are put the structures, depending from the conditions of terrain, and the distance from them, which in some cases perhaps can be tenth meters, is built (positioned) the pit 6, the bottom of which is covered with hay or straw, on which falls the immobilized pest (animal) without any danger of injury. In these cases it does not matter in which direction is the pest is moving—uphill or downhill the slop, where the only certainty is, that it/they will pass exactly on this path. To the power supply block 12 it is possible to switch on a solar panel 32.

The vertical electric truck 3 and 4 in the variant, shown on FIG. 8 allows to use narrow natural paths of pests P. In addition with it could be immobilized and/or exterminated pests P with differentiate height.

When the system is for extermination of small mammals (FIG. 9), the inclined platform 1 allows the pest P to climb freely Up toward funnel 2 on its way to the enticement 7. The sensor for presence and recognition 23, situated on the inner side and in middle of the cover 19′, sends a signal to the microprocessor 10, when in its space a pest P is present. In the desired moment the microprocessor passes a signal to the switch 11, which activates the relevant source of extermination influence 25, and kills the pest P. The device is provided with electricity by the power supply block 12. It is possible that the source of exterminating influence is a laser beam, ultrasound or electromagnetic radiation. In such case the recommended source of extermination influence is directed by parabolic aerial microwaves, which effect is revealed in another of our inventions—BG (64 219) US (U.S. Pat. No. 6,647,661). Then the device must be shielded, best with aluminum surfaces. The conical cover 21 in upper part of container 6 on main porter 22 does not allow the pest P to see the corpses of others, exterminated before it, which could frighten it on its way to the enticement 7. In the described way the corpse of an exterminated pest P falls in container 6 under the influence of its own weight.

When the system is implemented in the sewage network (FIG. 10) for extermination of mouse-like pest P, the furrow 2 consists of two inclined canvases, forming a bridge with an opening over the drain canal 26, along which the pest P is compulsory directed on his way toward the enticement 7. The sensor for presence and recognition 23 locate it on anyone of the canvases 2 and in the way described above activate the relevant sources of exterminated influence 25, which are powered by the power supply block 12. In this case the most suitable the sources of exterminating influence arc ultrasound sources. The corpse of exterminated pest P under its own weight slips along the canvas 2 and falls in drain canal 26, where the container 6 is. It is possible in the stream of the sewage pipe to place a net trap for corpse accumulation (not shown on figures).

When the system is for extermination of bird pests P (FIG. 11), the container 6 is hang on a cord 34, in such way that it is possible that the exterminated pests P to fall in it, landed on the rod-like platform 1 with screening surface 36 positioned at one end, on the way toward the enticement 7, situated in vessel-rack 35 under the rod-like platform 1. The sensor for presence and recognition 23 is placed at one end of platform 1, registers and recognizes the pest P and as described above the source of lethal influence 25 is activated, which is connected to the power supply block 12, in this case the most suitable source is laser ray. The exterminated pest P under its weight falls from the platform 1 in container 6. As an example of how the sensor for presence controls the exterminated influence we can consider the case, where the sensor for presence is photo-sensor, where the light-emitter is low-energy laser, which has an advantage over all other photo-sensors, since it can register presence of the smallest insect. When the pest P crosses the low-energy laser ray, immediately is switched on a high-energy laser, which exterminates it.

Safety of the systems, shown on FIG. 9 though FIG. 11, is achieved in every specific case with screening surfaces.

In the cases, when the systems are used in open areas (FIG. 6 through FIG. 8), they can be under continuous control by an operator, who trough an additional master switch can activate them manually when a past gets near by.

The operations of the structures/devices require standard safety measures as well. The presence of spark in open space make them not suitable for operation in environments where inflammable gases could be present, for example in coal mine galleries, natural gas in premises and others. The same applies for spaces with possibly inflammable dust, for example flower mill dust, gunpowder dust and other. In these cases, to use the structure/device, it must be provided with in additional safety feature, not shown on figures, which immediately blocks the action to structure/device when the concentrations of inflammable gases or dust reach dangerous levels.

To avoid the effect of electric discharges on radio-connections are applied measures like screening, neutralization and others (not shown on figures).

1. A method for pest control, where under the influence of enticement the pest climbs to certain height and than by an inclined surface is directed towards the extermination zone, where after registration of its presence an immobilization or extermination influence is applied, while the removal of the body of the immobilized or killed pest is insured by sliding down the slope or fall towards the respective place for collection of bodies, after that the influence is switched off and the device is in stand by mode expecting the next pest, characterized by that after registration of its presence in the extermination zone the pest is identified and immobilization of extermination influence, which could be electric discharge in a space limited by two electrodes where the pest is not necessary to touch neither one of the electrodes while moving towards the enticement, is applied only on an identified pre-defined type of pest.

2. The method for pest control of claim 1, characterized by that the extermination influence are laser beam or directed ultrasonic or electromagnetic waves, where the sensors which register the presence of the pest in the termination zone participate in its recognition and control of the extermination influence.

3. The method for pest control of claim 1 characterized by that the directing of the pest towards the extermination zone is achieved from all directions through an integrated corridor which insures that all pests will get into the extermination zone.

4. The method for pest control of claim 1 characterized by that the parameters of the immobilization or termination influence are S/W defined according to the identified pest type.

5. The method of pest control of claim 1, wherein the device for the pest control comprises an inclined platform (1), to which upper end is attached an inclined furrow (2), or which are positioned an upper electrode (3) and lower electrode (4), connected to the output leads of high voltage source (5), where under the furrow (2) is positioned a mobile container (6) into which is placed enticement (7), while light emitters (8), against each emitter there is a respective light sensors (9), which output is connected to the control input circuit of the switch (11), whose output is connected to the control input of the source for high voltage (5) characterized by that the inclined platform (1) is conical and together with an upper conical cover (19), is attached to the platform (1) with pop-up connections (13) through a transient circular platform (14), to create the integrated corridor (15) along the circumference of the device, while to the upper end of the conical inclined platform (1) by a circular platform (14) is affixed the upper larger opening of the furrow (2), which is funnel like with four sides, while the lower narrower opening is positioned centrally over a mobile container (6), into which is placed the enticement (7), where the electrodes (3) and (4) are affixed one after the other on the inside surface of the funnel like furrow (2), where the light emitters (8) and the respective light sensors (9) are placed in the corners on each two adjacent walls of the furrow (2) between the electrodes (3) and (4), where the upper electrode (3) is connected to the zero, while the lower electrode (4)—to the phase output of the source of high voltage (5), while the sensor (16) for removed container (6) is connected to the control circuit of the switch (17) in the input circuit of the source for high voltage (5), while on the inside and in the centre of the upper conical cover (19) is positioned a sensor for recognition (18), connected to the control circuit of the microprocessor (10), while another input of the microprocessor (10) is connected to the light sensors (9), while the output of the microprocessor (10) through the control input of the switch (11) is connected to the source of high voltage (5), where all electronic blocks are connected to a power supply block (12).

6. The method for pest control of claim 5, wherein the device is characterized by that in the funnel like furrow (2) are positioned more than one pair of electrodes (3) and (4) with the respective light emitters (8) and light sensors (9) in the zones between the electrodes, while the direct access to the enticement (7) is limited by the net (20), and along the entire circumference of the furrow (2) in the space between the electrodes are made openings (7′) to allow emanation of the enticement's (7) fragrance, while the access to which even for flying pests is insured by removing the upper conical cover (19) and the recognition sensor (18).

7. The method for pest control of claim 1, wherein the device for pest control, comprises an inclined platform (1), the zero electrodes (3) and the phase electrodes (4), connected to output leads of a source of high voltage (5), connected to a switch (11), where the furrow (2) with enticement (7) is positioned over a removable container (6), characterized by that, at the upper end of the inclined platform (1) through pop-up connections (1′) is attached a second conical platform, which is the furrow (2), at its upper end is affixed a third platform (2′), which is spherical, where the electrodes (3) and (4) are affixed one after the other on the outside surface of the conical platform (2) and the spherical platform (2′), in one of the two platforms is placed the enticement (7), along the entire circumference in the space between the electrodes are made openings (7′) for emanation of the flavour of the enticement (7), where the inclined platform (1) rests on the container (6), and with holders (24) are positioned sensors for presence and recognition (23), which are connected to the input of the microprocessor (10), through an output from the switch (11) and the input of the source of high voltage (5), which together with the remaining electronic blocks is connected to a power supply block (12).

8. The method for pest control of claim 1, wherein the device for pest control comprises a zero electrode (3) and a phase electrode (4) affixed on an inclined surface (1), where the electrodes (3) and (4) are connected to the output leads of a source of high voltage (5), where under the inclined surface (1) is positioned a container (6) with enticement (7), characterized by that, the container (6) is hung high on strings (34), where at the upper end of a beam (22) is affixed rod-like platform (1), which in this case is acting as the inclined surface, where the rod-like platform (1) is the zero electrode (3), at a distance, defined by the size of the pest P, with insulating ends (29) is positioned the phase electrode (4), at one of the ends of the platform (1) is placed the sensor for presence and recognition (23), whose output is connected to the input of the microprocessor (10), which through the switch (11) is connected to the input of the source of high voltage (5), all electronic blocks are connected to the power supply (12), while under the rod-like platform (1) is affixed a container (35) with enticement (7).

9. A system for pest control comprising an inclined platform (1), inclined furrow (2), zero electrode (3) and phase electrode (4), connected to the output leads of the source of high voltage (5), container (6) with enticement (7), wherein the inclined platform (1) is part of a slope on the landscape over which is formed the furrow (2) as sloping walls of a pit, which is the container (6) and at its bottom is placed the enticement (7), where the zero electrode (3) is placed directly over the surface along periphery of the container (6), while the phase electrode (4) is affixed, at a height defined by the size of a pest P, by insulated ends (29), fixed to supports (30), over each one is positioned a sensor for presence and recognition (23) with overlapping sectors of observation of respective zone of impact, the outputs of the sensors (23) are connected to the input of a microprocessor (10) via a transmitter (31), to the output of the microprocessor (10) through a switch (11) and is connected to the input lead of the source of high voltage (5), and a power supply block (12) is connected to a solar panel (32), which is placed on one of the supports (30) and/or a cable to the stationary power grid (33).

10. The system for pest control of claim 9, wherein the inclined furrow (2) is a slope of the landscape, where on both side of a trail of the pest P are placed two supports (30), over one of these is placed a sensor for presence and recognition (23), which via the transmitter (31) is connected to the input of the microprocessor (10), which output through a switch (11) is connected to a source of high voltage (5), where with insulated tips (29) between the two supports (30) is affixed electrode (4), which is the phase and is above the trail, while under it on the surface of the slope in such way as to surround the two supports (30), is place the zero electrode (3), where the pit (6) with enticement (7) is positioned at a distance down the slope.

11. The system for pest control, of claim 9, wherein the electrodes (3) and (4) are vertical and are positioned on both sides of the pest trail on the supports (30).

12. A device for pest control comprising an inclined platform (1) and removable container (6) with enticement (7), where to an upper end of the inclined platform (1) is placed in a funnel (2), wherein the inclined platform (1) is conical and to its upper end through an intermediate circular platform (14) with a square opening in the middle is affixed to a wider opening of a funnel (2), which has four walls, while its narrow opening is positioned centrally above the container (6), into which on a beam (22) is affixed a conical cover (21), on which is placed the enticement (7), where a sensor (16) for the removable container (6) is connected to a control input of switch (17) which is in an input circuit of a switch (11), where through pop-up links (13) above a wider opening of funnel (2) is placed a protective cover (19′), on an inside and in a centre of the cover (19′), is placed a sensor for presence and recognition (23), which output is connected to a specific input of a microprocessor (10) and sources of exterminating influence (25), positioned against each of the walls of the funnel (2), while a power supply block (12) is connected to the input leads of a switch (11) as well as all other electronic blocks.

13. The device of claim 12, wherein funnel (2) consists of two inclined canvases which form an interrupted bridge with an interruption (opening) above a sewage channel (26), where the enticement (7) is affixed between them with supports (27), while to the cross U-shaped consol (28), placed on both sides of the sewage channel (26) is placed the sensor for presence and recognition (23), where against each one of the canvases (2) are positioned the sources of exterminating influence (25).

14. The device of claim 12, wherein the container (6) is hung high on cords (34), where at an upper end of the extended beam (22) is attached a rod like platform (1), at one end of it is placed the sensor for presence and recognition (23) and the source of exterminating influence (5), while at the other end of the rod like platform (1) is positioned screening surface (36), while under the rod like platform (1) is hung container (35) with enticement (7).
